(19) United States
(12) Patent Application Publication
(10) Pub. No.: US 2017/0242156 A1
(43) Pub. Date: Aug. 24, 2017

(54) TWO-DIMENSIONAL SQUARE-LATTICE PHOTONIC CRYSTAL WITH CROSS-SHAPED CONNECTING RODS AND ROTATED SQUARE RODS

(71) Applicant: SHENZHEN UNIVERSITY, Shenzhen (CN)

(72) Inventors: Zhengbiao Ouyang, Shenzhen (CN); Guohua Wen, Shenzhen (CN)

(73) Assignee: SHENZHEN UNIVERSITY

(21) Appl. No.: 15/447,112

(22) Filed: Mar. 2, 2017

Related U.S. Application Data
(63) Continuation of application No. PCT/CN2015/090889, filed on Sep. 28, 2015.

(30) Foreign Application Priority Data
Sep. 29, 2014 (CN) 201410515302.2

(51) Int. Cl. G02B 1/00; G02B 6/122

(52) U.S. Cl. CPC G02B 1/005; G02B 6/1225; G02B 6/1223

(57) ABSTRACT

A two-dimensional square lattice photonic crystal having cross-shaped connecting rods and rotating square rods. The two-dimensional square lattice photonic crystal comprises a high refractive index dielectric cylinder and a low refractive index background dielectric cylinder. The photonic crystal structure is formed by cells in square lattice arrangement. The cells of the square lattice photonic crystal are composed of high refractive index rotating square rods, cross-shaped planar dielectric rods and background dielectrics. The high refractive index rotating square rods are connected to the cross-shaped planar dielectric rods. The lattice constant of the square lattice photonic crystal is a, the side length d of each rotating square cylinder is O.SIa to 0.64a, the rotation angle of each rotating square cylinder rod is 2.300 to 87.70, and the width t of each cross-shaped planar dielectric rod is 0.032a to 0.072 a. The distance G of the cross-shaped planar dielectric rods that move, from bottom to top and from left to right within a lattice period relative to the rotating square rods is 0.4a to 0.6a. According to the photonic crystal structure, the integration level of a light path can be provided easily, and a large absolute forbidden band can be achieved.

### CROSS-REFERENCE TO RELATED APPLICATIONS

This application is a continuation of International Patent Application No. PCT/CN2015/090889 with a filing date of Sep. 28, 2015, designating the United States, now pending, and further claims priority to Chinese Patent. Application No. 201410515302,2 with a filing date of Sep. 29, 2014. The content of the aforementioned application, including any intervening amendments thereto, are incorporated herein by reference.

### TECHNICAL FIELD

The present invention relates to a two-dimensional photonic crystal with a wide absolute photonic bandgap.

### BACKGROUND OF THE PRESENT INVENTION

In 1987, E. Yablonovitch from Bell Laboratories of the United States, who was discussing about how to inhibit spontaneous radiation, and S. John from Princeton University, who was discussing about a photon localization, respectively and independently proposed the concept of a photonic crystal (PhC). The PhC is a structure material formed in a way that dielectric materials are periodically arranged in space and an artificial crystal which is composed of two or more than two materials with different dielectric constants.

One of the main challenges in modern optics is the control of light. With the continuous development of the optical communication and computer technology, the control and operation of optical signals have become more and more important. The PhC has drawn much attention due to its character that the PhC is capable of completely forbidding or allowing light with a specific frequency and a specific direction to pass through.

Since an electromagnetic field mode is totally forbidden to exist in an absolute photonic bandgap, the spontaneous radiation of an electron is inhibited when the energy band of the electron overlaps with the absolute photonic bandgap of the PhC. The PhC with the absolute photonic bandgap can change the interaction between an electromagnetic or optical field and a substance and improve the performance of optical devices by controlling the spontaneous radiation. The PhCs can be applied to semiconductor lasers, solar cells, high-quality resonant, cavities and filters. The electromagnetic field modes that disappear in the absolute photonic bandgap can also change the states of many atomic, molecular and excitonic systems.

The distribution of dielectric materials in the unit cell of a PhC highly influences the bandgap, the design of the bandgap highly influences the application of the PhC, and in particular wide absolute photonic bandgap is very effective for controlling a wide-band signal.

Regardless of polarizations and wave vectors, no optical wave with a frequency within the absolute photonic bandgap can pass through a PhC. The PhC with wide photonic bandgap can be used for fabricating optical waveguides, PhC fibers, negative refractive index imaging devices, PhC lasers with defect mode, and defect cavities. The PhC with wide absolute photonic bandgap can inhibit harmful spontaneous radiation in the PhC lasers with defect mode, and particularly in the case that the spontaneous radiation spectral region is very wide. Wider absolute photonic bandgap is necessary or obtaining a PhC resonant cavity with a narrow resonance peak. In various optical devices, the polarization-independent absolute photonic bandgap is very important Since many PhC devices require wide absolute photonic photonic bandgap, it is significant to design the PhCs with wide absolute photonic bandgap; and developing an effective method for inding wide photonic bandgap is also significant. Therefore, scientists around the world are engaging to design various PhC, structures to obtain wide absolute photonic bandgap.

### SUMMARY OF PRESENT INVENTION

The present invention aims at overcoming the defects in the prior art to provide a two-dimensional square-lattice PhC with large relative value of absolute photonic bandgap and easy integration of optical circuits.

The objectives of the present invention are realized through technical solutions below.

A two-dimensional square-lattice PhC with cross-shaped connecting rods and rotated square rods according to the present invention includes a dielectric cylinder with high refractive index and a background dielectric cylinder with low refractive index; the PhC structure is formed from a unit cell arranged according to a square lattice; said unit cell of the square-lattice PhC is composed of a rotated square rod with high refractive index, a planar cross-shaped dielectric rod and a background dielectric; the rotated square rod with high refractive index is connected with the planar cross-shaped dielectric rod; the lattice constant of the square-lattice PhC is a; the side length d of the rotated square cylinder is 0.51a-0.64a, the rotating angle α of the rotated square cylinder rod is 2.30°-87.7°, and the width t of the planar cross-shaped dielectric rod is 0.032a-0.072a; and the distance G of the planar cross-shaped dielectric rod moving from bottom to top and from left to right in one lattice period relative to the rotated square rod is 0.4a-0.6a.

The dielectric with high refractive index is a dielectric with refractive index greater than 2.

The dielectric with high refractive index is silicon, gallium arsenide, or titanium dioxide.

The dielectric with high refractive index is silicon, and the refractive index is 3.4.

The background dielectric is a dielectric with to refractive index.

The background dielectric with low refractive index is a dielectric with refractive index smaller than 1.6.

The background dielectric with low refractive index is air, vacuum, magnesium fluoride, or silicon dioxide.

The background dielectric with low refractive index is air.

The horizontal distance from the leftmost end to the rightmost end of the planar cross-shaped dielectric rod of the PhC cell is a; and the vertical distance from the uppermost end to the lowermost end of the planar cross-shaped dielectric rod of the PhC unit cell is a.

The dielectric with high refractive index is silicon; the dielectric with low refractive index is air; 2.30°+90°×n≦α≦87.7°+90°×n, where n is 0 or other natural number; 0.51a≦d≦0.64a, 0.032a≦t≦0.072a, and 0.4a≦G≦0.6a; and a relative value of the absolute photonic bandgap of the PhC structure is greater than 10%.

The dielectric with high refractive index is silicon; the dielectric, with low refractive index is air; d=0.57a; t=0.048a; G=0.5a; α=21.94°+90°×n, where n is 0 or other natural number; and the relative value of the absolute photonic bandgap is 14.30%.

The two-dimensional square-lattice PhC with the cross-shaped connecting rods and the rotated square rods according to the present invention can be widely applied to the design of the large-scale optical integrated circuits Compared with the prior art, the two-dimensional square-lattice PhC with the cross-shaped connecting rods and the rotated square rods has the positive effects below.

(1) A great number of detailed studies are carried out by using the plane wave expansion (PWE) method to obtain a maximum relative value of the absolute photonic bandgap and corresponding parameters thereof; and a ratio of the width of the absolute photonic bandgap to the center frequency of the photonic bandgap is generally used as an evaluation index of the width of photonic bandgap and called as the relative value of the absolute photonic bandgap.

(2) The PhC structure has a very large absolute photonic bandgap, which can bring about great convenience and flexibility to the design and manufacture of the PhC devices.

(3) In the optical integrated circuits of the PhC, it is easy to realize connection and coupling among different optical elements and among different optical circuits; and by adopting the square lattice structure, the optical circuits are simplified and the integration level of the optical circuits can be easily improved.

(4) The design is simple, the PhC is easy to produce, and the production cost is decreased.

### DESCRIPTION OF THE DRAWINGS

FIG. 1 is the structural schematic diagram of the unit cell of the two-dimensional square-lattice photonic crystal with cross-shaped connecting rods and rotated square rods according to the present invention.

FIG. 2 is the structural diagram of the photonic bands corresponding to the unit cell parameters adopted in embodiment 1.

FIGS. 3 is the structural diagram of the photonic bands corresponding to the unit cell parameters adopted in embodiment 2.

FIG. 4 is the structural diagram of the photonic bands corresponding to the unit cell parameters adopted in embodiment 3.

FIG. 5 is the structural diagram of the photonic bands corresponding to the unit cell parameters adopted in embodiment 4.

FIG. 6 is the structural diagram of the photonic bands corresponding to the unit cell parameters adopted in embodiment 5.

FIG. 7 is the structural diagram of the photonic bands corresponding to the unit cell parameters adopted in embodiment 6.

FIG. 8 is the structural diagram of the photonic bands corresponding to the unit cell parameters adopted in embodiment 7.

FIG. 9 is the structural diagram of the photonic bands corresponding to the unit cell parameters adopted in embodiment 8.

FIG. 10 is the structural diagram of the photonic bands corresponding to the unit cell parameters adopted in embodiment 10.

FIG. 11 is the structural diagram of the photonic bands corresponding to the unit cell parameters adopted in embodiment 11.

FIG. 12 is the structural diagram of the photonic bands corresponding to the unit cell parameters adopted in embodiment 12.

### DETAILED DESCRIPTION OF PREFERRED EMBODIMENTS

The present invention is further described in, detail below in combination with the drawings and specific embodiments:

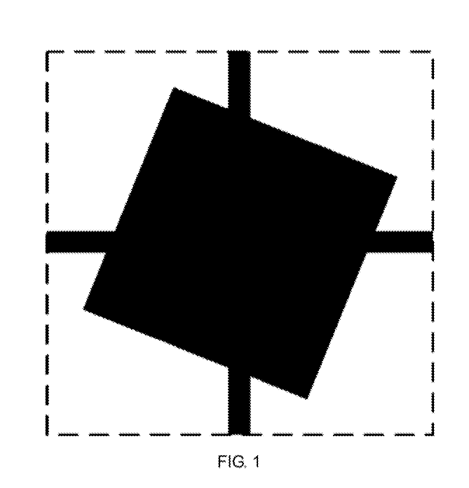

The two-dimensional square-lattice PhC with cross-shaped connecting rods and rotated square rods according to the present invention includes a dielectric cylinder with high refractive index and a background dielectric cylinder with low refractive index. FIG. 1 shows the unit cell of the PhC, and the PhC structure is formed from the unit cell arranged according to a square lattice. The unit cell of the square-lattice PhC is composed of a rotated square rod with high refractive index, a planar cross-shaped dielectric rod and a background dielectric; and the rotated square rod with high refractive index is connected with the planar cross-shaped dielectric rod. The unit cell structure has four characteristic parameters as, follows: the side length d of the rotated square cylinder which is 0.51a-a64a the rotating angle α of the rotated square, cylinder which is 2.30°+90°×n≦α≦87.7°+90°×n, wherein n=0, 1, 2, . . . (nεN) and n is a natural number; the width t of the planar cross-shaped dielectric rod which is 0.032a-0.072a, wherein a is the lattice constant; and the distance G of the planar cross-shaped dielectric rod moving from bottom to top and from left to right in one lattice period relative to the rotated square cylinder which is 0.4a-0.6a: the horizontal distance from the leftmost end to the rightmost end of the planar cross-shaped dielectric rod of the PhC unit cell which is a; and the vertical distance from the uppermost end to the lowermost end of the planar cross-shaped dielectric rod of the PhC unit cell which is a.

### Embodiment 1

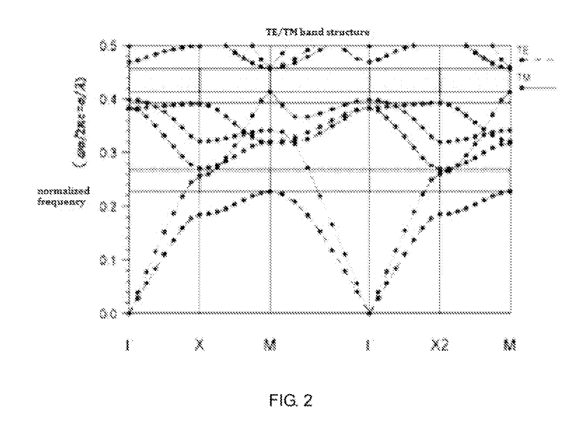

Silicon is used as the dielectric with high refractive index; air is used as the dielectric with low refractive index: d=0.57a; t=0.048a: G=0.5a; and α=2.30°. It can be seen from a numerical simulation result of the present embodiment as shown in FIG. 2 that a relative value of the wide absolute photonic bandgap is 10%.

### Embodiment 2

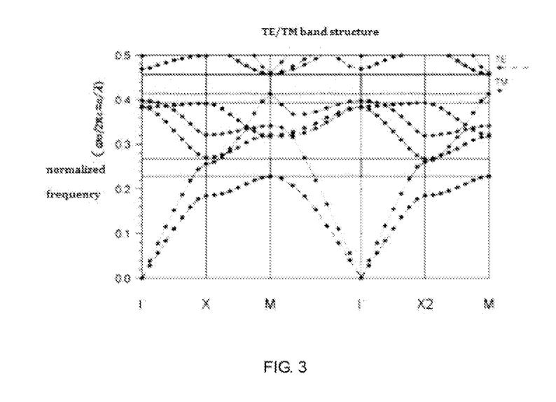

Silicon is used as the dielectric with high refractive index; air is used as the dielectric with low refractive index; d=0.57a: t=0.048a; G=0.5a: and α=87.7°. It can be seen from a numerical simulation result of the present embodiment as shown in FIG. 3 that a relative value of the wide absolute photonic bandgap is 10%.

### Embodiment 3

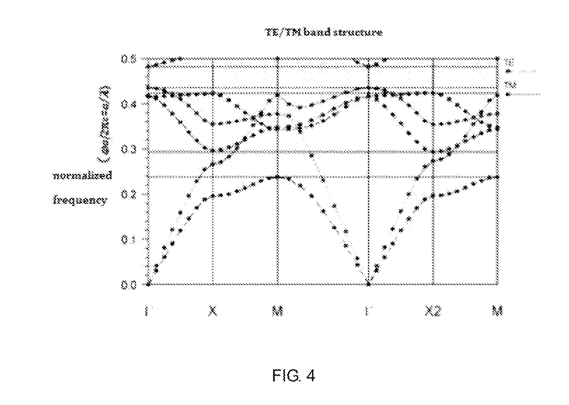

Silicon is used as the dielectric with high refractive index; air is used as the dielectric with low refractive index; d=0.51a; t=0.048a; G=0.5a; and α=21.94°. It can be seen from a numerical simulation result of the present embodiment as shown in FIG. 4 that a relative value of the wide absolute photonic bandgap is 10.46%.

### Embodiment 4

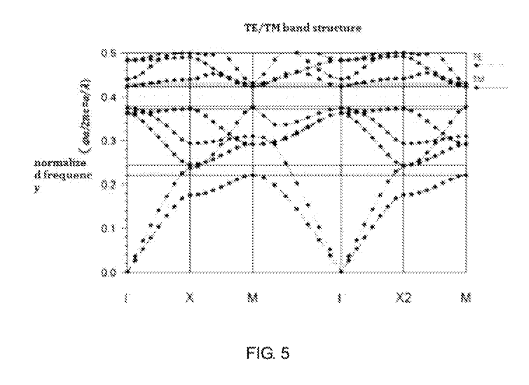

Silicon is used as the dielectric with high refractive index; air is used as the dielectric with low refractive index: d=0.64a; t=0.048a: G=0.5a; and α=21.94°. It can be seen from a numerical simulation result of the present embodiment as shown in FIG. 5 that a relative value of the wide absolute photonic bandgap is 11.53%.

### Embodiment 5

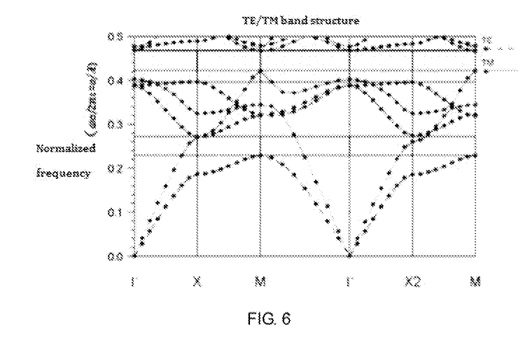

Silicon is used as the dielectric with high refractive index; air is used as the dielectric with low refractive index; d=0.57a; t=0.032a; G=0.5a; and α=21.94°. It can be seen from a numerical simulation result of the present embodiment as shown in FIG. 6 that a relative value of the wide absolute photonic bandgap is 10.10%.

### Embodiment 6

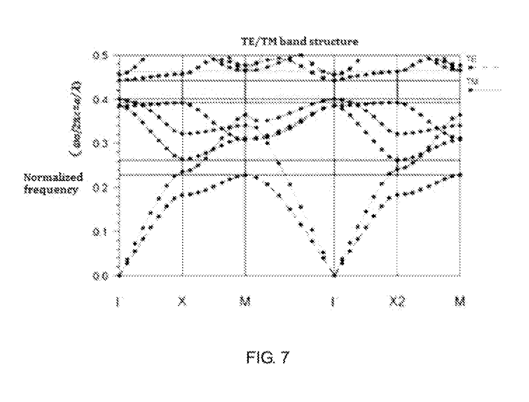

Silicon is used as the dielectric with high refractive index; air is used as the dielectric with low refractive index; d=0.57a; t=0.072a; G=0.5a; and α=21.94°. It can be seen from a numerical simulation result of the present embodiment as shown in FIG. 7 that a relative value of the wide absolute photonic bandgap is 10.08%.

### Embodiment 7

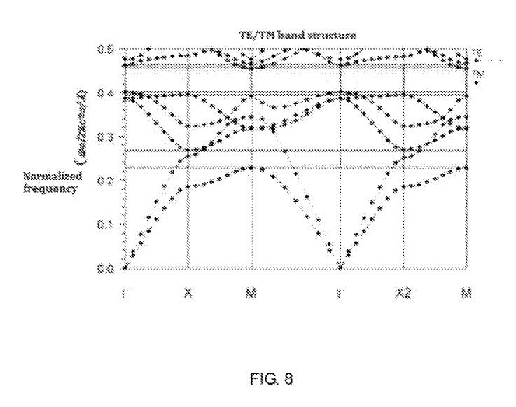

Silicon is used as the dielectric with high refractive index; air is used as the dielectric with low refractive index; α=21.94° ; d=0.57a: t=0.048a; and G=0.4a. It can be seen from a numerical simulation result of the present embodiment as shown in FIG. 8 that a relative value of the wide absolute photonic bandgap is 12.62%.

### Embodiment 8

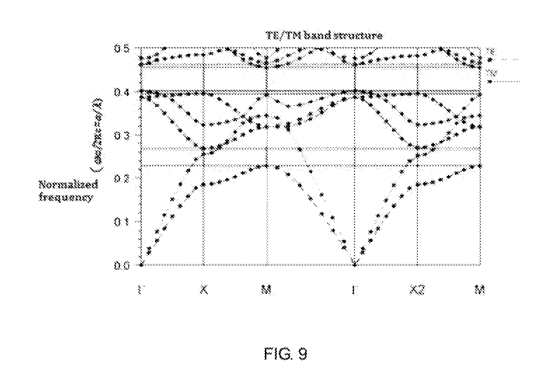

Silicon is used as the dielectric with high refractive index; air is used, as the dielectric with low refractive index; α=21.94°; d=0.57a; t=0.048a; and G=0.6a. It can be seen from a numerical simulation result of the present embodiment as shown in FIG. 9 that a relative value of the wide absolute photonic bandgap is 12.54%.

### Embodiment 9

Silicon is used as the dielectric with high refractive index; air is used as the dielectric with low refractive index; a=1.55*0.431 μm≈0.668 μm; the corresponding structural parameters are: d=0.2457 μm; t=0.0207 μm; G=0.2155 μm; and α=21.94°. The structure has a relative value of the absolute photonic bandgap of 14.03% at the communication wave band of 1.55 μm.

### Embodiment 10

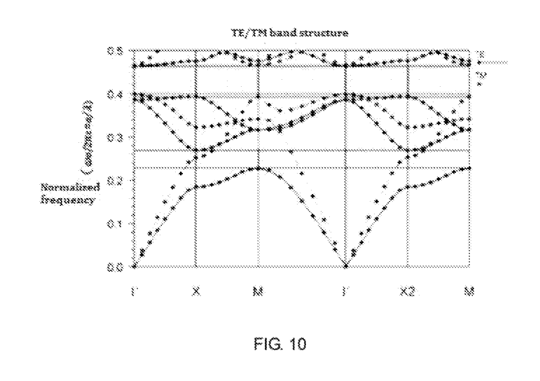

Silicon is used as the dielectric with high refractive index; air is used as the dielectric, with low refractive index; n=0, d=0.57a; t=0.048a; G=0.5a; and α=21.94°. It can be seen from a numerical simulation result of the present embodiment as shown in FIG. 10 that a relative value of the wide absolute photonic bandgap is 14.30%.

### Embodiment 11

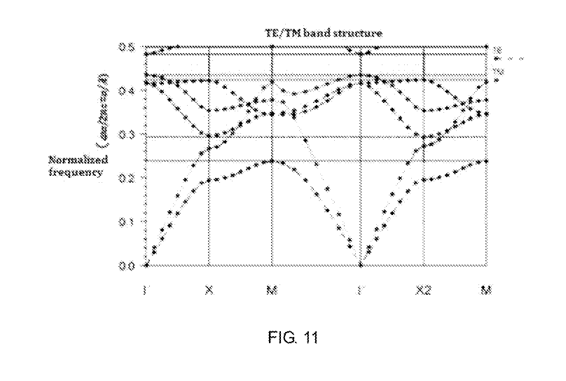

Silicon is used as the dielectric with high refractive index; air is used as the dielectric with low refractive index; α=21.94°; t=0.048a; G=0.5a; and d=0.51a. It can be seen from a numerical simulation result of the present embodiment as shown in FIG. 11 that a relative value of the wide absolute photonic bandgap is 10.46%.

### Embodiment 12

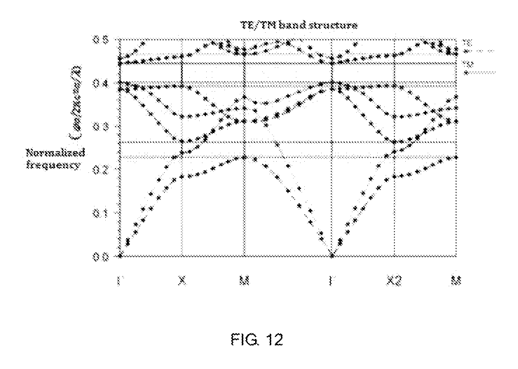

Silicon is used as the dielectric with high refractive index; air is used as the dielectric with low refractive index; α=21.91°; d=0.57a; G=0.5a; and t=0.068a. It can be seen from a numerical simulation result of the present embodiment as shown in FIG. 12 that a relative value of the wide absolute photonic bandgap is 10.50%.

The above detailed description is only for clearly understanding the present invention and should not be taken as a limit to the present invention. Therefore, any modification made to the present invention is obvious to those skilled in the art.

We claim:

1. A two-dimensional square-lattice photonic crystal with cross-shaped connecting rods and rotated square rods, wherein a high refractive index dielectric cylinder and a low refractive index background dielectric cylinder; the photonic crystal structure is formed from a unit cell arranged according to a square lattice; said unit cell of the square-lattice photonic crystal is composed of a rotated square rod with high refractive index, a planar cross-shaped dielectric rod and a background dielectric; the rotated square rod with high refractive index is connected with the planar cross-shaped dielectric rod; the lattice constant of the square-lattice photonic crystal is a; the side length d of the rotated square cylinder is 0.51a-0.64a, the rotating angle α of the rotated square cylinder rod is 2.30°-87.7°, and the width t of the planar cross-shaped dielectric rod is 0.032a-0.072a; and the distance G of the planar cross-shaped dielectric rod moving from bottom to top and from left to right in one lattice period relative to the rotated square rods is 0.4a-0.6a.

2. The two-dimensional square-lattice photonic crystal with the cross-shaped connecting rods and the rotated square rods according to claim 1, wherein the dielectric with high refractive index is a dielectric with refractive index greater than 2.

3. The two-dimensional square-lattice photonic crystal with the cross-shaped connecting rods and the rotated square rods according to claim 1, wherein the dielectric with high refractive index is silicon, gallium arsenide, or titanium dioxide.

4. The two-dimensional square-lattice photonic crystal with the cross-shaped connecting rods and the rotated square rods according to claim 3, wherein the dielectric with high refractive index is silicon, and the refractive index is 3.4.

5. The two-dimensional square-lattice photonic crystal with the cross-shaped connecting rods and the rotated square rods according to claim 1, wherein the background dielectric is a dielectric with a dielectric with low refractive index smaller than 1.6.

6. The two-dimensional square-lattice photonic crystal with the cross-shaped connecting rods and the rotated square rods according to claim 1, wherein the background dielectric with low refractive index is air, vacuum, magnesium fluoride, or silicon dioxide.

7. The two-dimensional square-lattice photonic crystal with the cross-shaped connecting rods and the rotated square rods according to claim 6, wherein the dielectric with low refractive index is air.

8. The two-dimensional square-lattice photonic crystal with the cross-shaped connecting rods and the rotated square rods according to claim 1, wherein the horizontal distance from the leftmost end to the rightmost end of the planar cross-shaped dielectric rod of the photonic crystal unit cell is a; and
the vertical distance from the uppermost end to the lowermost end of the planar cross-shaped dielectric rod of the photonic crystal unit cell is a.

9. The two-dimensional square-lattice photonic crystal with the cross-shaped connecting rods and the rotated square rods according to claim 1, wherein the dielectric with high refractive index is silicon; the dielectric with low refractive index is air; 2.30°+90°×n≦87.7°+90°×n, where n is 0 or other natural number; 0.51a≦d≦0.64a, 0.032a≦t≦0.072a, and 0.4a≦G≦0.6a, and the relative value of the absolute photonic bandgap of the photonic crystal structure is greater than 10%.

10. The two-dimensional square-lattice photonic crystal with the cross-shaped connecting rods and the rotated square rods according to claim 1, wherein the dielectric with high refractive index is silicon; the dielectric with low refractive index is air; d=0.57a, t=0.048a, G=0.5a, α=21.94°+90°×n, where n is 0 or other natural number; and a relative value of the absolute photonic bandgap band is 14.30%.
